(19) United States
(12) Patent Application Publication
(10) Pub. No.: US 2021/0364721 A1
(43) Pub. Date: Nov. 25, 2021

(54) FIELD REPAIRABLE FIBER OPTIC CASSETTE

(71) Applicant: COMMSCOPE CONNECTIVITY BELGIUM BVBA, Hickory, NC (US)

(72) Inventors: David Jan Irma VAN BAELEN, Winksele (BE); Diederik HOUBEN, Santa Ana, CA (US)

(73) Assignee: COMMSCOPE CONNECTIVITY BELGIUM BVBA, Hickory, NC (US)

(21) Appl. No.: 17/041,283

(22) PCT Filed: Mar. 25, 2019
(86) PCT No.: PCT/EP2019/057476

§ 371 Date: Sep. 24, 2020

Related U.S. Application Data
(60) Provisional application No. 62/648,140, filed on Mar. 26, 2018.

(51) Int. Cl. G02B 6/44

(52) U.S. Cl. CPC G02B 6/4454

(57) ABSTRACT

A fiber optic telecommunications device includes a fiber optic cassette. A plurality of connection locations are defined on the body, wherein optical fibers that are factory-terminated with fiber optic connectors extend from the cable at the signal entry location to the connection locations of the body for connection to external fiber optic connectors. A repair splice protector is positioned within the interior, the repair splice protector configured for supporting at least one repair splice.

### CROSS-REFERENCE TO RELATED APPLICATION

This application claims the benefit of U.S. Patent Application Ser. No. 62/648,140, filed on Mar. 26, 2018, the disclosure of which is incorporated herein by reference in its entirety.

### TECHNICAL FIELD

The present disclosure relates generally to fiber optic telecommunications equipment. More specifically, the present disclosure relates to a fiber optic cassette designed for high density applications. The cassette also includes features for providing repairability of the connection locations within the cassette.

### BACKGROUND

Optical fiber distribution systems include fiber terminations and other equipment which is typically rack mounted. Various concerns exist for the optical fiber distribution systems, including density, ease of use, cable management, and field repairability. There is a continuing need for improvements in the optical fiber distribution area.

### SUMMARY

The present disclosure relates to a fiber optic telecommunications device. The telecommunications device includes a fiber optic cassette that is rack-mountable in high density applications, wherein the cassette also includes features for providing post factory repairability of the connection locations within the cassette.

The disclosure relates to a cassette that can be opened in the field for re-splicing a damaged connector within the module.

According to one example embodiment, the fiber optic cassette includes a body defining an interior. A fiber optic signal entry location is defined on the body for a fiber optic signal to enter the interior of the cassette via a fiber optic cable. A plurality of connection locations are defined on the body, wherein optical fibers that are factory-terminated with fiber optic connectors extend from the cable at the signal entry location to the connection locations for connection to external fiber optic connectors. A repair splice protector is positioned within the interior, the repair splice protector configured for supporting at least one repair splice for one of the optical fibers within the cassette if a factory-terminated connector gets damaged.

According to another aspect, the disclosure relates to a method of assembling a fiber optic cassette, the method comprising providing a fiber optic signal entry location on the cassette, extending a plurality of optical fibers into an interior of the cassette from the signal entry location, factory-terminating the optical fibers with fiber optic connectors, coupling to the factory-terminated fiber optic connectors to connection locations within the interior of the cassette for connection to external fiber optic connectors to come from an exterior of the cassette, and providing a repair splice protector within the interior configured for supporting at least one repair splice for one of the optical fibers within the cassette if a factory-terminated connector gets damaged.

According to another aspect, the disclosure relates to a fiber optic cassette comprising a body defining a front and an opposite rear and an enclosed interior, a removable cover coupled to the body to enclose the interior, a fiber optic signal entry location defined at the rear of the body for a fiber optic signal to enter the interior of the cassette via a fiber optic cable, an adapter block defining a plurality of fiber optic adapters located at the front of the body, the adapter block removably mounted to the cassette body with a snap-fit interlock, each adapter of the block including a front outer end, a rear inner end, and internal structures which allow mating of fiber optic connectors that are mounted to the front and rear ends, respectively, wherein optical fibers that are factory-terminated with fiber optic connectors extend from the cable at the signal entry location to the rear ends of at least some of the fiber optic adapters of the snap-fit adapter block for relaying the fiber optic signal to external fiber optic connectors to be coupled to the front outer ends of the adapters, and a repair splice protector positioned within the interior, the repair splice protector configured for supporting at least one repair splice for one of the optical fibers within the cassette if a factory-terminated connector gets damaged.

According to another aspect, the disclosure relates to a fiber optic cassette including a plurality of connectorized fibers within the cassette, wherein the cassette includes a splice protector for holding single fiber splices, the splice protector configured to support a number of splices that is less than a number of the connectorized fibers within the cassette. According to one embodiment, the splice protector may be a repair splice protector for supporting at least one post-factory splice within the cassette.

According to another aspect, the disclosure relates to a post-factory repaired fiber optic cassette, wherein the cassette includes a plurality of single fiber connectors terminated to fibers within the cassette, at least one of the single fiber connectors being a post-factory spliced connector.

It should be noted that the term “factory-terminated” used in the present disclosure may include “direct” termination of a fiber optic connector to an end of an optical fiber at the factory level that does not involve a splice operation. However, the term “factory terminated” may also include factory-splicing of a fiber optic connector pigtail to a length of optical fiber at the factory level.

A variety of additional inventive aspects will be set forth in the description that follows. The inventive aspects can relate to individual features and combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a front, right, top perspective view of an example embodiment of a fiber optic cassette having features that are examples of inventive aspects in accordance with the present disclosure, the cassette shown without a cover to illustrate the internal aspects;

FIG. 2 is a top view of the fiber optic cassette of FIG. 1;

FIG. 3 is a rear, left, top perspective view of the fiber optic cassette of FIGS. 1 and 2, shown with an alternative version of a splice protector insert within the cassette;

FIG. 4 is a top view of the fiber optic cassette of FIG. 3, illustrating an example fiber routing configuration for two fibers having factory terminated connectors;

FIG. 5 illustrates the fiber optic cassette of FIG. 4 with an example fiber routing configuration when a repair slice is used for one of the fibers;

FIG. 6 illustrates the fiber optic cassette of FIG. 4 with an alternative fiber routing configuration that can be used for one of the fibers that has a factory terminated connector;

FIG. 7 is a front, right, top perspective view of another embodiment of a fiber optic cassette having features that are similar to those of the cassette of FIGS. 1-6;

FIG. 7A illustrates the fiber optic cassette of FIG. 7 with the cover thereof removed to show the internal features thereof;

FIG. 8 is a top view of the fiber optic cassette of FIG. 7A;

FIG. 9 illustrates the fiber optic cassette of FIGS. 7-8 with two different examples of splice protector inserts that may be used therein, the splice protector inserts shown exploded off the cassette body;

FIG. 10 illustrates an example of an internal fiber optic connector that has been terminated to one of the optical fibers coming into one of the cassettes of FIGS. 1-9;

FIG. 11 illustrates an example of a twelve-fiber ribbon that has been factory spliced to internal connectors leading to the adapters of one of the cassettes of FIGS. 1-9 instead of direct factory termination of the optical fibers coming into the cassettes;

FIG. 12 illustrates the fiber optic cassette of FIGS. 3-6 snap-fit within an example rack-mountable telecommunications fixture in the form of a hinged tray;

FIG. 13 is a rear, top perspective view of another embodiment of a fiber optic cassette having features that are similar to those of the cassettes of FIGS. 1-9, the cassette having an alternative location for the splice protector insert;

FIG. 14 is a rear, left, top perspective view of the fiber optic cassette of FIG. 13;

FIG. 15 illustrates the fiber optic cassette of FIGS. 13 and 14 with an example fiber routing configuration that uses one of the channels of the splice protector insert for routing a fiber to utilize the full cassette width;

FIG. 16 is a front, right, top perspective view of another embodiment of a fiber optic cassette having features that are similar to those of the cassette of FIGS. 13-15, the cassette utilizing alternative versions of cable management features therewithin;

FIG. 17 is a top view of the fiber optic cassette of FIG. 16;

FIG. 18 illustrates the cassette of FIG. 17 with the cable management features exploded off the cassette body;

FIG. 19 is a front, right, top perspective view of another embodiment of a fiber optic cassette having features that are similar to those of the cassettes of FIGS. 13-18, the cassette having an alternative version of a splice protector insert that includes integrally formed cable management spools;

FIG. 20 is a rear, left, top perspective view of the fiber optic cassette of FIG. 19;

FIG. 21 is a top view of the fiber optic cassette of FIG. 19;

FIG. 22 illustrates the fiber optic cassette of FIG. 19 with the internal features shown in an exploded configuration;

FIG. 23 is a front, right, top perspective view of the splice protector insert that is configured to be mounted within the cassette of FIGS. 19-22 shown in isolation;

FIG. 24 is a rear, left, top perspective view of the splice protector insert of FIG. 23;

FIG. 25 is a rear, top perspective view of another embodiment of a fiber optic cassette having features that are similar to those of the cassette of FIGS. 19-22, the cassette having an alternative version of a splice protector insert that includes the integrally formed cable management spools;

FIG. 26 is a front, right, top perspective view of the splice protector insert that is configured to be mounted within the cassette of FIG. 25;

FIG. 27 is a rear, left, top perspective view of another embodiment of a fiber optic cassette that includes a splice protector insert for repair splices as well as splice protectors for holding splices that are used for factory splicing of the internal connectors to fiber ribbons;

FIG. 28 is a right, perspective view of the fiber optic cassette of FIG. 27;

FIG. 29 illustrates the fiber optic cassette of FIGS. 27 and 28 with an example fiber routing configuration for a factory spliced internal connector;

FIG. 30 illustrates a fiber optic cassette similar to that of FIGS. 27-29 that includes additional molded cable management spools that are used to illustrate an alternative fiber routing configuration for a factory spliced internal connector;

FIG. 31 is a front, right, top perspective view of a fiber optic cassette having similar features to those shown in FIGS. 27-30, the cassette having an alternative version of the splice protectors for factory splicing of the internal connectors;

FIG. 32 is a rear, left, top perspective view of the fiber optic cassette of FIG. 31;

FIG. 33 is top view of the fiber optic cassette of FIG. 31;

FIG. 34 illustrates the cassette of FIGS. 31-33 with two different examples of splice protector inserts for repair splices that may be used therein, the repair splice protector inserts shown exploded off the cassette body;

FIG. 35 illustrates the cassette of FIG. 34 with one of the repair splice protector inserts mounted to the cassette body, the splice protector insert having a different configuration than the insert shown in the cassette of FIGS. 31-33; and

FIG. 36 illustrates a rear, left, top perspective of a fiber optic cassette having features that are similar to the cassette shown in FIGS. 19-22, the cassette including hingedly mounted adapter blocks for facilitating access to the internal connectors within the cassette.

### DETAILED DESCRIPTION

Reference will now be made in detail to examples of inventive aspects of the present disclosure which are illustrated in the accompanying drawings. Wherever possible, the same reference numbers will be used throughout the drawings to refer to the same or like parts.

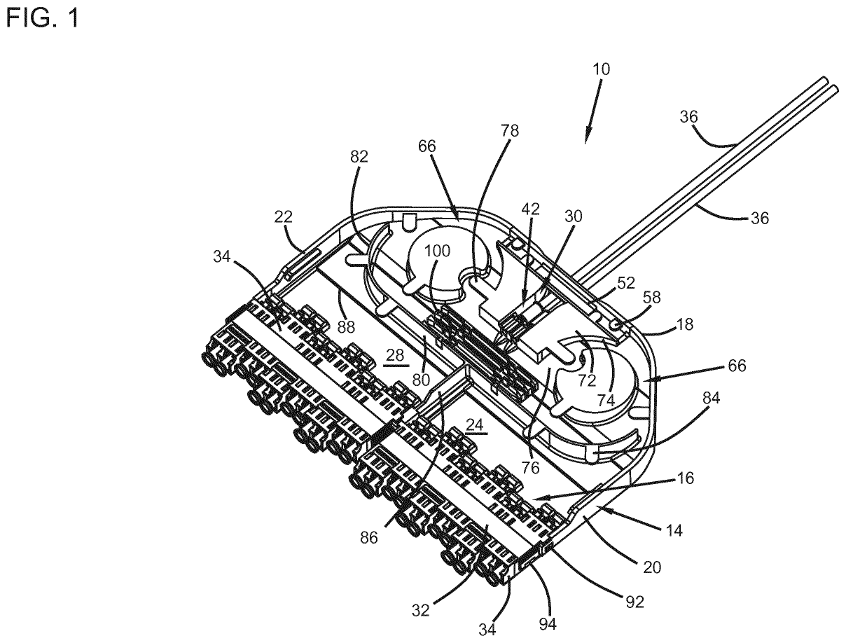

Now referring to FIGS. 1-6, an embodiment of a fiber optic cassette 10 that includes features that are examples of inventive aspects in accordance with the present disclosure is illustrated.

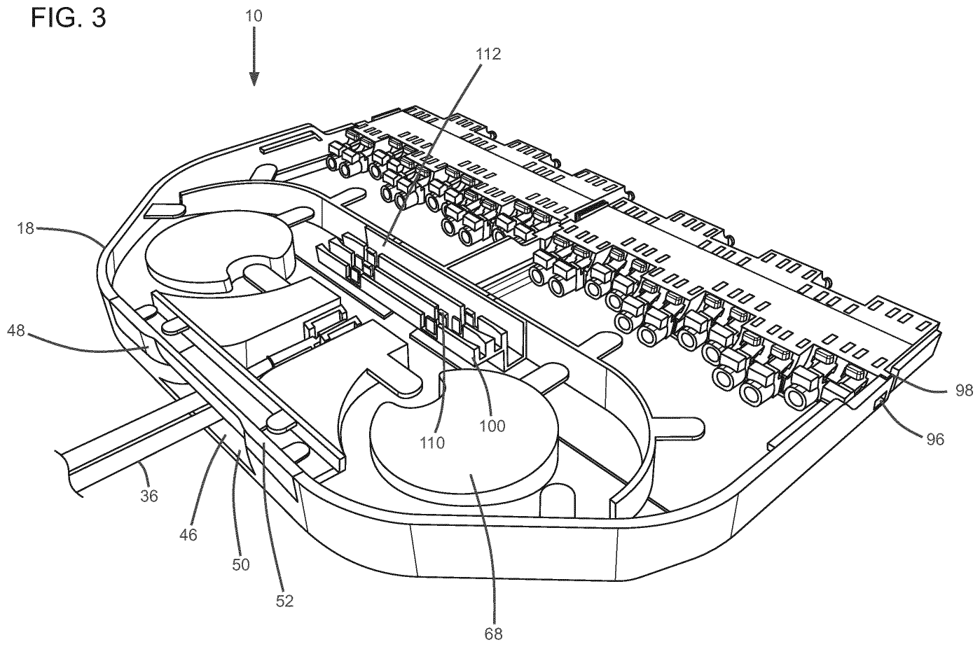

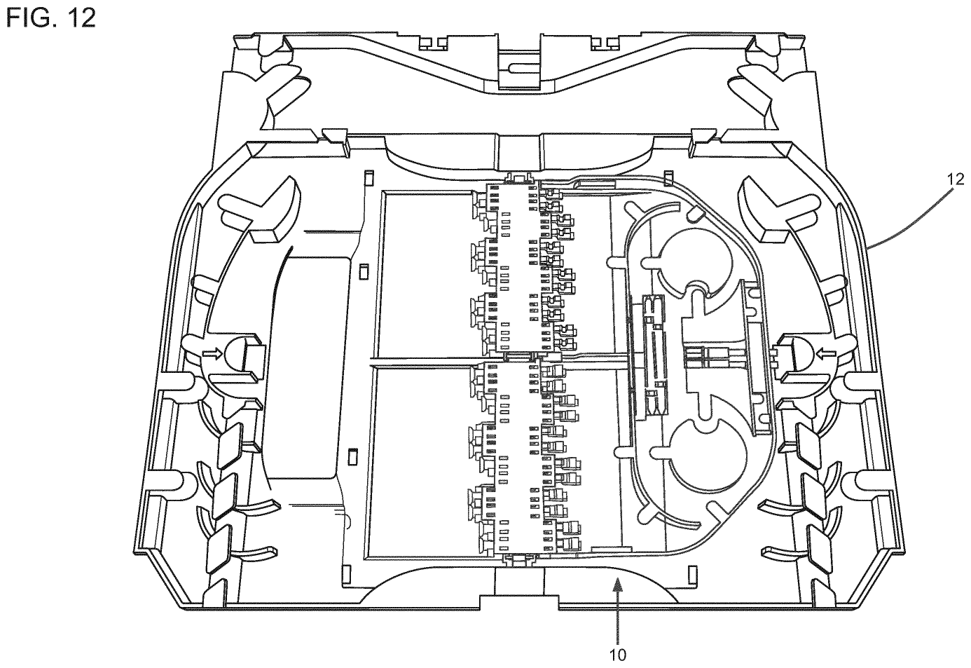

The fiber optic cassette 10 may be configured for mounting in high density environments (e.g., such as rack mounted enclosures). According to an example aspect, the fiber optic cassette 10 of FIGS. 1-6 and other embodiments of the cassettes described herein may be configured for mounting in telecommunications systems such as those described in PCT Publication No. WO 2017/103234, the entire disclosure of which is incorporated herein by reference. For example, FIG. 12 illustrates the fiber optic cassette 10 of FIGS. 3-6 snap-fit within an example rack-mountable telecommunications fixture in the form of a hinged tray 12 of such a system.

According to another example aspect, the fiber optic cassettes of the present disclosure may be configured for mounting in a telecommunications systems such as those described in PCT Publication No. WO 2013/052854, the entire disclosure of which is incorporated herein by reference.

Even though specific examples of environments that may utilize the cassettes of the present disclosure have been noted above, it should be noted that the inventive cassettes of the present disclosure may be utilized in other environments or applications.

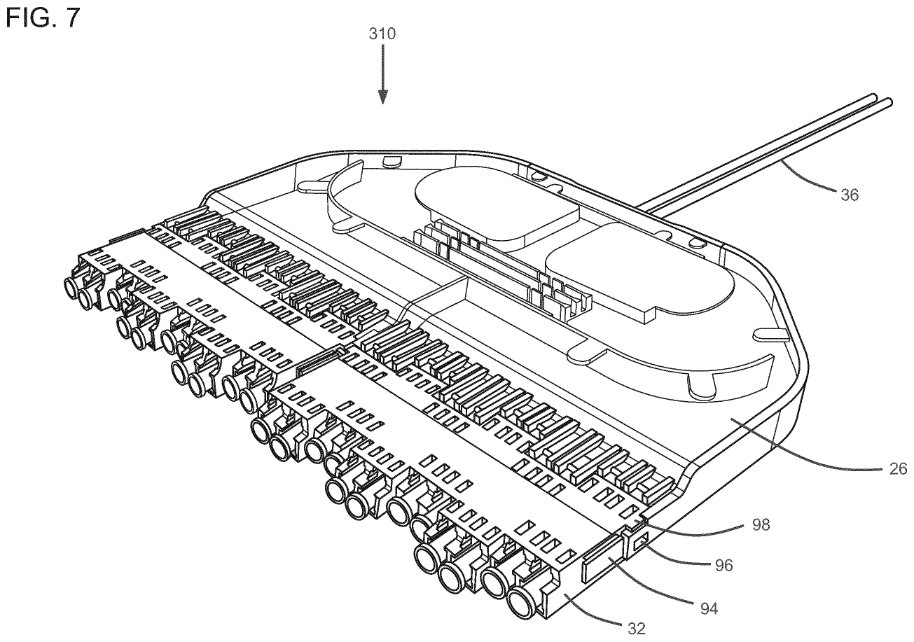

Referring back to FIGS. 1-6., the fiber optic cassette 10 includes a body 14 defining an open front 16, a rear wall 18, a pair of sidewalls 20, 22 (i.e., right and left sidewalls), a bottom wall 24, and a top in the form of a removable cover 26 (shown in the example cassette of FIG. 7), all defining an interior 28 of the cassette 10.

Cassette body 14 defines a cable entry location 30 which in the illustrated embodiment is at the rear wall 18.

At the front 16 of the cassette body 14, as shown, two adapter blocks 32 are configured to be snap-fit to the cassette 10 in a side-by-side configuration, closing off the front 16 of the cassette 10. Fiber optic adapters 34 (e.g., LC or SC format) are defined by the adapter blocks 32, as will be discussed in further detail below. The adapters 34 provide connection locations for the cassette 10 in receiving exterior fiber optic connectors for optically continuing the signals input into the cassettes from cables 36 entering at the rear of the cassette 10.

In general, the top defined by the cover 26 (shown in FIG. 7) and the bottom wall 24 of the cassette 10 are generally parallel to each other and define the major surfaces of cassette body 14. Sidewalls 20, 22, front 16, and rear wall 18 define the minor sides of cassette body 14. The cassette 10 can be oriented in any position, so that the top and bottom surfaces can be reversed, or positioned vertically, or at some other orientation. The cover 26 may be configured to be snap-fit to the cassette body 14 or may be mounted with fasteners.

As noted previously, in the fiber optic cassette 10 of FIGS. 1-6, fiber optic signals are input into the cassette 10 via the fiber optic cables 36 at the cable entry location 30. Each cable 36 entering the cassette is coupled to the cassette 10 at the cable entry location 30 with a crimp tube 38 and a crimp ring 40 which crimps the jacket and the strength member of the cable 36 to the crimp tube 38. In the depicted embodiment, two fiber optic cables 36 are mounted to the cassette 10 in a side-by-side orientation.

A pocket 42 is defined at the cable entry location 30. The pocket 42 is designed to capture the crimp tubes 38 in a side-by-side arrangement for retention within the cassette body 14. The pocket 42 is shaped to receive hex ends 44 of each crimp tube 38 to fix the cables 36 with respect to the cassette body 14. The cover 26 is configured to capture the cables 36 once they are received within the pocket 42.

As shown, the pocket 42 is provided in an inset portion 46 defined at the center of right and left portions 48, 50 of the rear wall 18 of the cassette. The portions 48, 50 of the rear wall 18 surrounding the pocket 42 provide gradual curves as the portions 48, 50 extend from the pocket 42 to left and right of the rear wall 18. Thus, when the cables 36 placed in the pocket 42 are bent in either direction toward the right side or the left side of the cassette 10, bend radius protection is provided with the curved portions 48, 50 of the rear wall 18. This provides a built-in bend radius protection structure that may eliminate the need for a separate boot for each of the cables 36.

The cassette 10 shown in FIGS. 1-6 includes a bridge structure 52 forming at least a portion of the rear wall 18. The bridge structure 52 is positioned over the pocket 42 defining the cable entry location 30 and provides a pathway or channel 54 for fibers 56 to pass thereover during routing of the fibers 56 inside the cassette 10. The bridge structure 52 may be provided as a removable insert or may be molded integrally with the cassette body 14. In the depicted embodiment, the bridge structure 52 includes cable retention fingers 58 extending into the channel 54 for retaining fibers 56 therein.

In the interior 28, connectorized fibers 56 (e.g., connectors defining an LC format) that are broken out from each cable 36 are led toward the front 16 of the cassette 10 and coupled to rears 60 of the adapters 34 defined by each of the adapter blocks 32, wherein they can mate with exterior connectors coupled at the fronts 62 of the adapters 34. An example of an interior connector 64 that has been terminated to one of the fibers 56 extending from the input cables 36 is illustrated in FIG. 10. According to the depicted embodiment, the interior connector 64 is a connector that is terminated to a 250 micron fiber 56 extending into the cassette 10 without a strain relief boot attached at the back of the connector 64. If enough room is provided within the cassette 10, internal connectors 64 may also be standard connectors that include strain relief boots.

As will be discussed in further detail, the interior 28 of the cassette body 14 of the cassette 10 of FIGS. 1-6 generally defines two distinct chambers 66, each one including a radius limiter 68 (e.g., in the form of a spool) with cable retention fingers 70 extending therefrom. As will be discussed, various fiber routing configurations are possible around the two radius limiters 68 toward the front adapters 34 as the optical fibers 56 are led from the input cables 36 at the back.

In the version of the cassette 10 shown in FIGS. 1-6, the cassette body 14 defines a pair of bulkheads 72 at sides of the cable pocket 42. The bulkheads 72 define curved surfaces 74 that cooperate with the curved surfaces of the spools 68 on both sides of the cassette 10 to define fiber routing pathways 76 for the fibers 56 broken out from the cables 36. The bulkheads 72 may also include cable retention fingers 78 for retaining the fibers 56.

A wall 80 (integrally formed in the depicted example) extends from the right to the left side of the cassette body 14 with curved portions 82 at the ends. The wall 80 also cooperates with the spools 68 in defining fiber pathways 76 for routing of the fibers 56. The wall 80 includes cable retention fingers 84 that face forwardly for retaining fibers 56 adjacent the front of the wall 80.

The wall 80 defines a central divider portion 86 that generally separates the adapters 34 (and mated connectors 64) of the right adapter block 32 from the adapters 34 (and mated connectors 64) of the left adapter block 32. The center divider portion 86 helps keep the fibers 56 organized by preventing crossover of the fibers 56 to the opposing sides of the cassette body 14. The wall 80, including the central divider portion 86, provides additional strength to the structure of the cassette 10 by increasing stiffness and rigidity thereof.

As shown in FIGS. 1-6, the bottom wall 24 of the cassette body 14 also defines a raised edge 88 spaced apart from the inner rear ends 60 of the adapters 34. The raised edge 88 acts as a stopper when removing connectors 64 so as to limit damage to the connectors 64 by contact with the wall 80.

Examples of certain fiber routing will be discussed in further detail below.

Still referring to FIGS. 1-6, as noted above, the front 16 of the cassette body 14 is closed off by a pair of the adapter blocks 32. In the depicted embodiments, twelve LC type adapters 34 are provided on each block 32. The depicted cassette 10 is configured such that two blocks 32 having twelve LC adapters 34 each can be mounted side by side providing a total of twenty-four connection locations at the front 16 of the cassette 10. In the embodiment shown, if an SC type footprint is used, the cassette 10 can accommodate up to twelve connections total at the front 16 thereof.

Each of the adapter blocks 32 illustrated in the cassette 10 of FIGS. 1-6 defines a generally one-piece molded body 90 that defines a plurality of integrally formed adapters 34 (LC format in the depicted example) for optically connecting fibers 56 terminated with connectors 64. Each of the adapter blocks 32 defines a plurality of adapters 34 provided in a stacked arrangement in a longitudinal direction D, such as from a right side to a left side of the adapter block 32, wherein every other adapter 34 of the block 32 of adapters 34 is staggered in a transverse direction T, such as in a front-to-back direction with respect to an adjacent adapter 34 for facilitating finger access. Since the adapter blocks 32 provide staggered adapters, the front end of the cover 26 of the cassette 10 is configured with an intermating shape.

Each adapter block 32 defines a ramped tab 92 adjacent a dovetail mounting structure 94 on each of the right and left sides of the adapter block 32. The ramped tabs 92 allow the adapter blocks 32 to be snap-fit and become part of the fiber optic cassette 10, closing off the front 16 of the cassette 10.

The ramped tabs 92 adjacent the dovetail mounting structures 94 are configured to snap into openings 96 provided on the right and left sidewalls 20, 22 and at the center divider portion 86 of the wall 80 at the front 16 of cassette body 14. The right and left sidewalls 20, 22 of the cassette body 14 are elastically flexible in receiving the ramped tabs 92. On each side of each adapter block 32, a protrusion 98 that is above the ramped tab 92 also provides a guiding effect in sliding the ramped tab 92 into the openings 96 and sits on top of a front portion of the cassette 10 after the adapter block 32 has been snap-fit thereto, as shown in FIG. 1.

Once the adapter blocks 32 have been snap-fit to the cassettes 10, the dovetail mounting structures 94 of the adapter blocks 32 allow the entire cassette 10 to be mounted to other telecommunications equipment as discussed in the disclosures incorporated herein by reference.

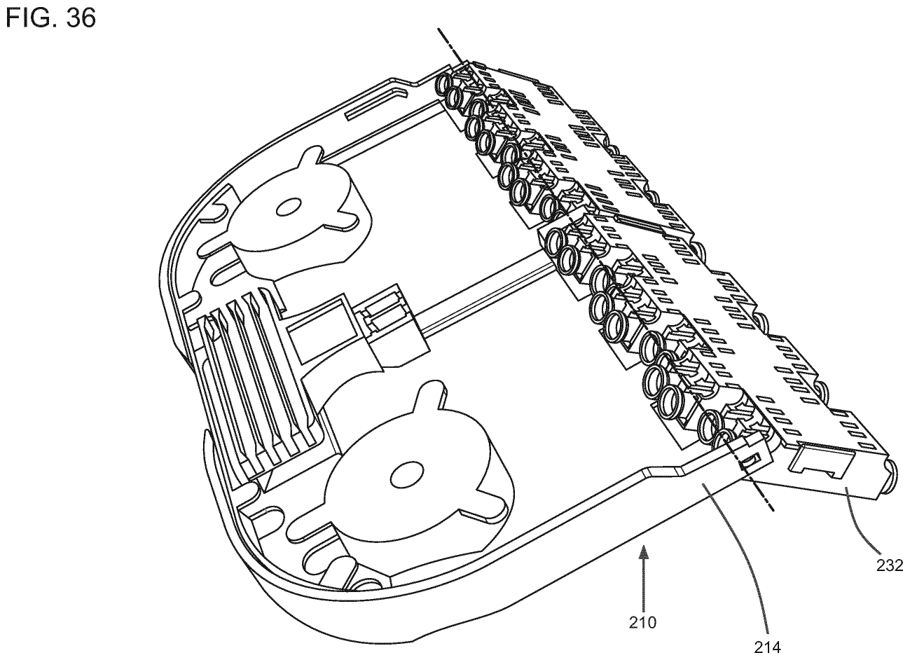

Even though the adapter blocks 32 have been shown as fixedly snap-fit to the front portions 16 of the cassettes 10, FIG. 36 illustrates a unique version of a fiber optic cassette 210 that includes hingedly mounted adapter blocks 232 for facilitating access to the internal connectors within the cassette 210. Such adapter blocks 232 may include circular tabs that snap into circular openings at the right and left sidewalls of the cassette body 214 for providing the pivotability effect.

Referring back to FIGS. 1-6, the modular nature of the snap-fit adapter blocks 32 provides the advantage of being able to replace the blocks 32 themselves if there is any damage to the connection locations. However, with respect to the individual internal connectors 64, the inventive features of the fiber optic cassettes 10 of the present disclosure, as will be described in further detail, allow field-repairability of the connectorized fibers 56 within the cassettes 10.

As shown in FIGS. 1-6, the cassette 10 includes within the interior 28, a splice support tray 100 (i.e., splice protector) that allows re-splicing or repairing of any damaged connectors 64 within the interior 28 of the cassette 10. The splice protector 100 may also be referred to as a repair splice protector since it is used for the purpose of repair of fibers 56. If one of the connectors 64 terminating the fibers 56 broken out from input cables 36 is damaged and needs replacement, the cover 26 of the cassette 10 can simply be removed, the damaged connector 64 removed from the rear end 60 of the corresponding adapter 34, and a new connector 64 can be spliced to the corresponding fiber 56. The splice support tray or protector 100 is configured to support such repair splices 102.

According to certain embodiments, parts of the cassette 10, such as the cover 26 thereof, may include certain indicia, such as a different color from standard similar-shaped cassettes, to indicate that the cassette 10 is a field-repairable one. Other types of indicia such as markings or stickers may also be used for such indication.

In the embodiment depicted in FIGS. 1-6, the splice protector 100 is shown as a removable insert that is slidably mounted to the cassette body 14. In the depicted embodiment, the splice protector 100 defines dovetail shaped tabs 104 that are slidably inserted into complementary notches 106 defined on the wall structure 80 when mounting the splice protector 100 into the cassette 10.

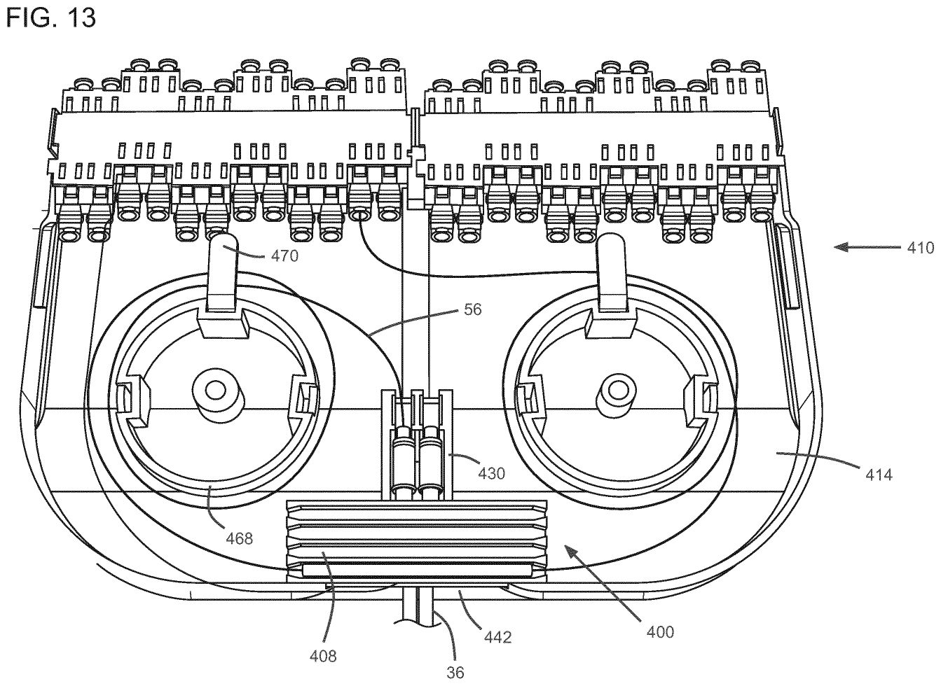

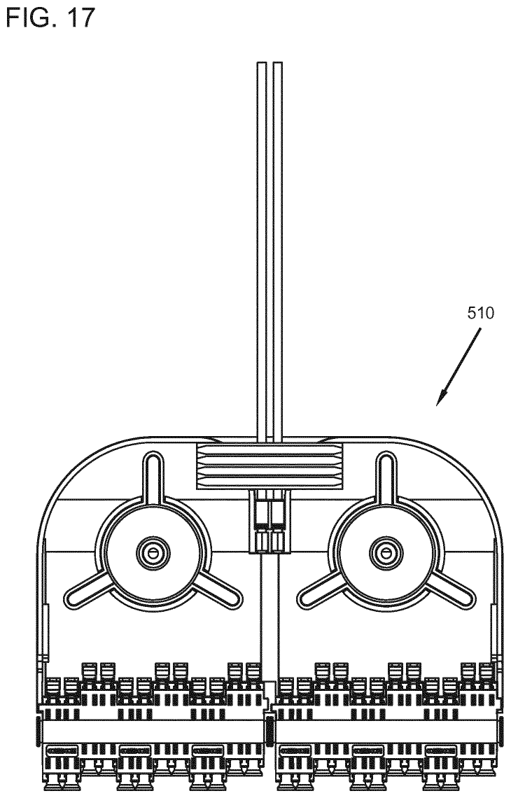

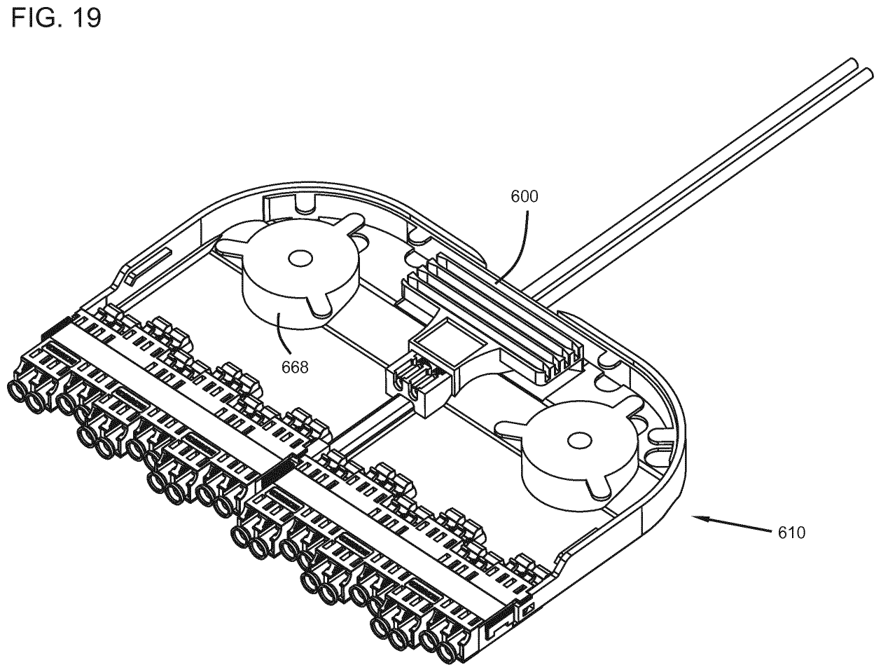

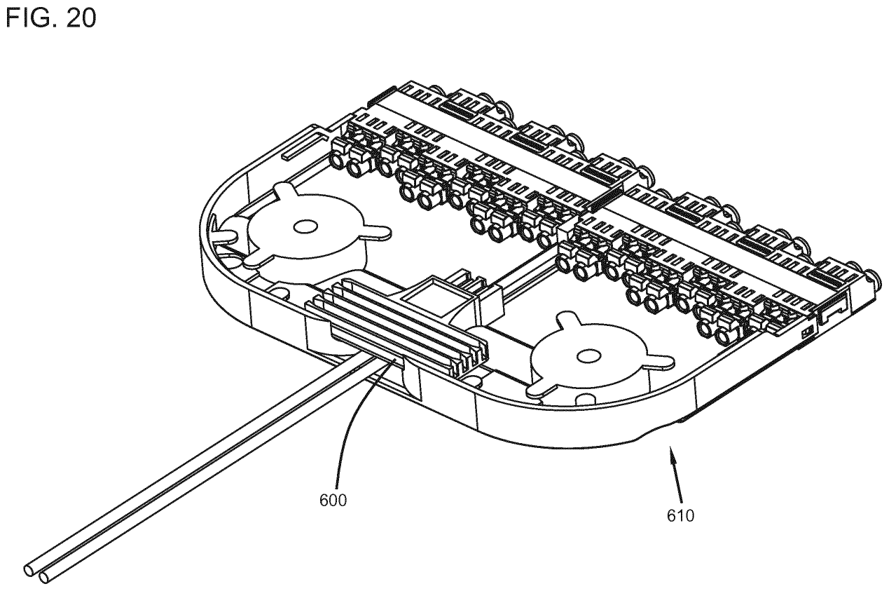

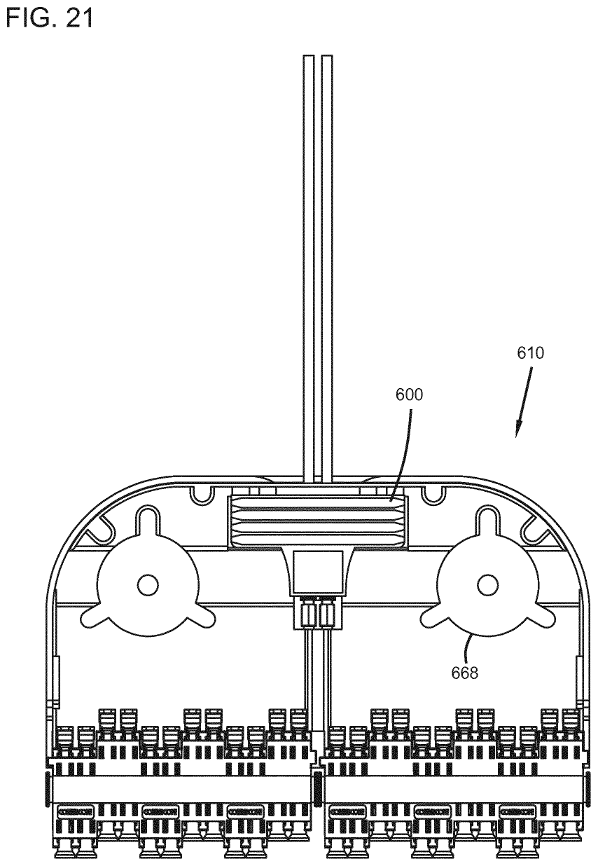

The splice protector 100 defines a plurality of separate channels 108 for holding repair splices 102. Depending on the needed application, the splice protector 100 can have different numbers of channels 108. In certain embodiments as shown, the splice protector 100 can have splice retention arms 110 that flexibly cantilever in frictionally holding the splices 102. In other embodiments, the splice protector 100 may simply have smooth channels 108 (e.g., in versions of the cassettes shown in FIGS. 13-26) for holding splices 102.

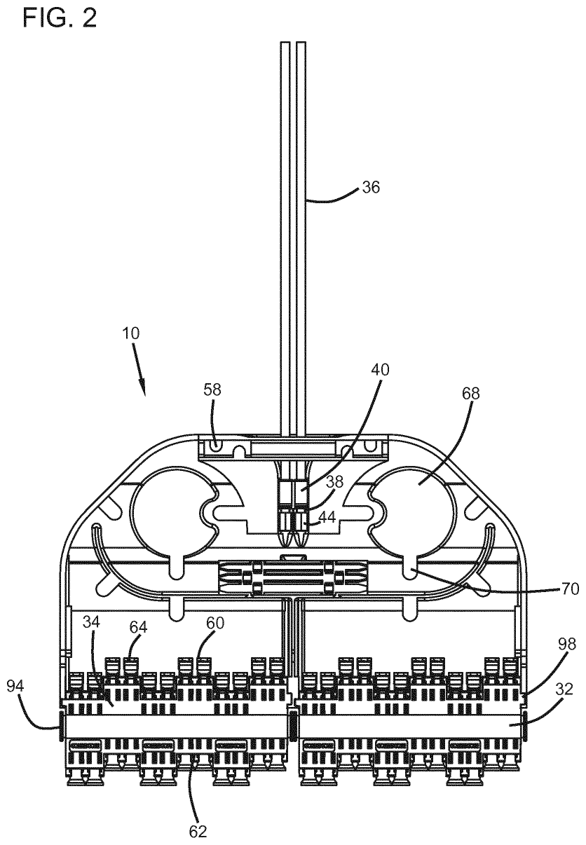

In the version of the repair splice protector 100 shown in FIGS. 1 and 2, the splice protector 100 defines three channels 108 sized to hold or support three 45 mm splices 102 (or ANT splices). In the version of the splice protector insert 100 shown in FIGS. 3-6, the splice protector 100 defines two channels 108 that are sized to hold 45 mm splices 102 (or ANT splices) and a third channel 112 that is large enough to hold additional 45 mm splices 102 (or ANT splices). It should be noted that the large channel 112 may be used to hold a factory twelve-fiber ribbon splice 114 as will be discussed in further detail below.

Fibers 56 leading into the cassette body 14 may be provided with excess length between the cable crimp or entry locations 30 and the inner LC connectors 64 coupled to the rears 60 of the adapters 34 for allowing field-repairability of the cassette 10. According to certain embodiments, an excess length of 70 centimeters (cm) to 1.2 meters (m) may be provided between the crimp location 30 and the internal connectors 64 for allowing the splicing operation. Since severe bending of the fibers 56 is to be avoided, the excess length of optical fiber 56 is managed via the radius limiters 68 within the cassette 10.

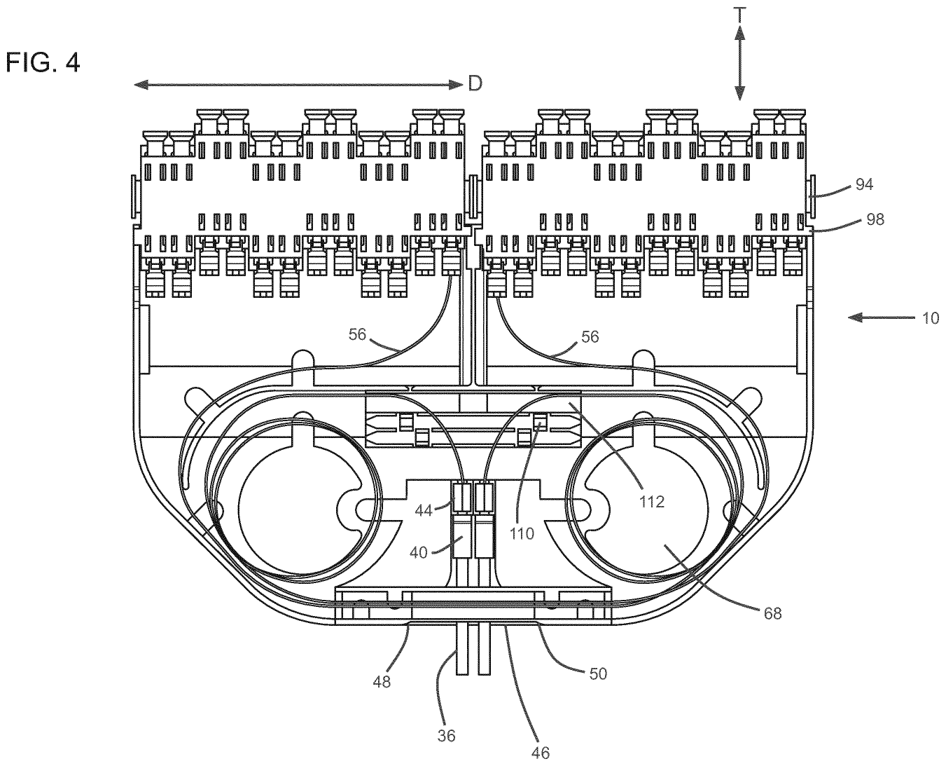

Referring specifically to FIG. 4, an example fiber routing configuration for two fibers 56 having factory terminated connectors 64 is illustrated. In the depicted example, fibers 56 from the right input cable 36 lead to the left adapter block 32 and fibers 56 from the left input cable 36 lead to the right adapter block 32. For example, a fiber 56 extending from the right input cable 36 is spooled around the right radius limiter 68 before being led across the bridge at the back of the cassette in a right-to-left direction and around the front of the curved portion of the wall to one of the adapters of the left block. A similar routing may be used for a fiber extending from the left input cable, with the directions reversed relative to the fiber from the right cable.

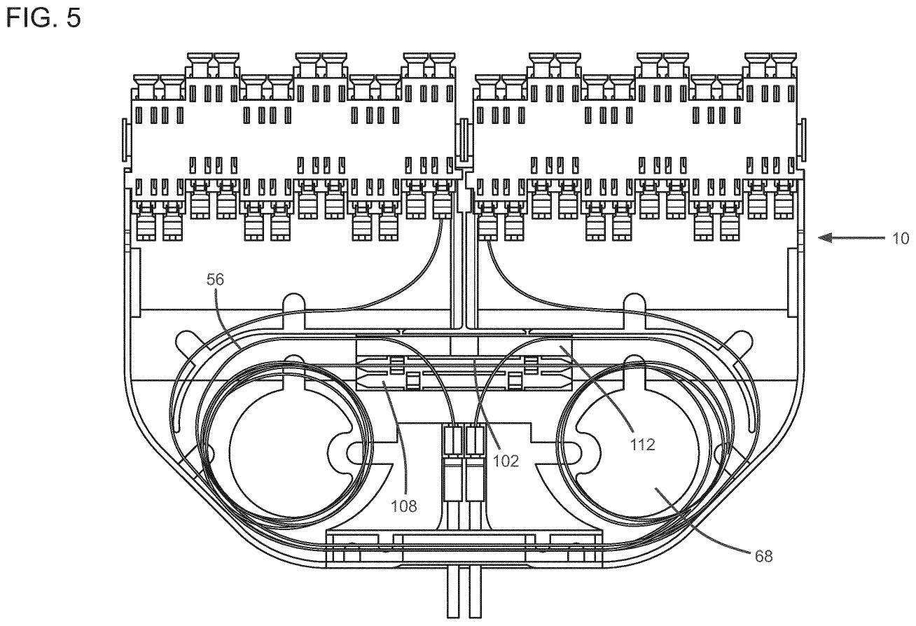

FIG. 5 illustrates an example fiber routing configuration when a repair slice is used for one of the fibers. As shown, a fiber from the right input cable can be directed toward the right side of the cassette, around the right radius limiter, toward the rear, through the bridge 52 in a right-to-left direction, toward the front, and the around the left radius limiter 68. The fiber 56 is then spliced to a length of fiber 56 that is terminated to a functional fiber optic connector 64. The splice 102 is supported in one of the channels 108 of the splice protector 100. The terminated fiber 56 extends from the right side of the splice 102 and follows a similar path to a length of fiber 56 before the fiber 56 was repaired. For example, after being spliced, the fiber 56 is spooled around the right radius limiter 68, before being led across the bridge 52 at the back of the cassette 10 in a right-to-left direction and around the front of the curved portion 82 of the wall 80 to one of the adapters 34 of the left block 32.

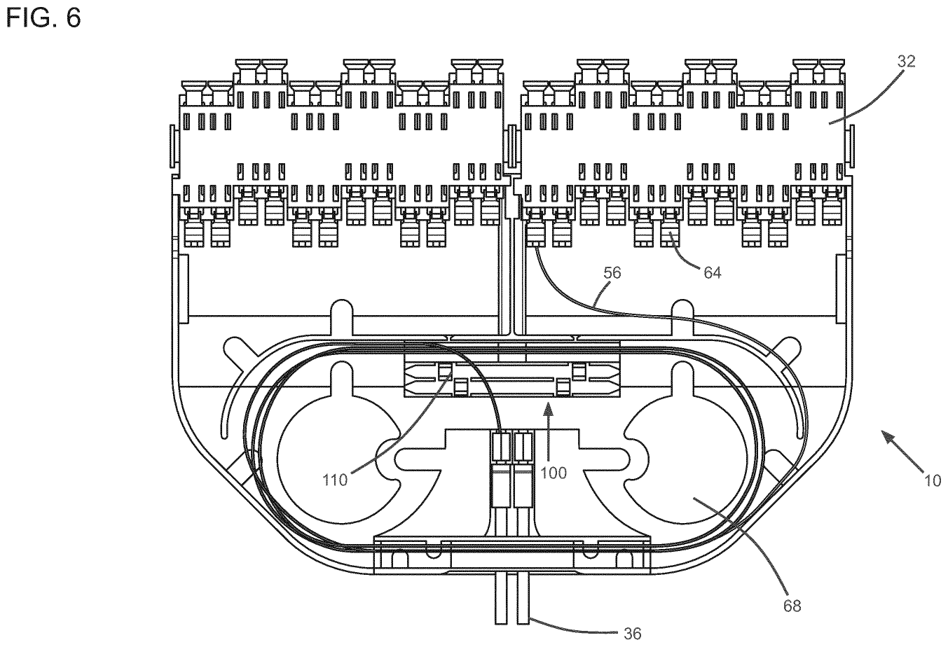

FIG. 6 illustrates an alternative fiber routing configuration that can be used for one of the fibers 56 that has a factory terminated connector 64. In the routing configuration illustrated in FIG. 6, the fiber 56 is first routed around the right radius limiter 68, across the bridge 52 from a right-to-left direction, around the left radius limiter 68, and across one of the channels 108 of the splice protector 100 from a left-to-right direction before being led once again around the right radius limiter 68 and back across the bridge 52 before being led toward the front 16 of the cassette 10. Thus, the routing configuration illustrated in FIG. 6 essentially uses both of the radius limiters 68 and both the bridge 52 and one of the channels 108 of the splice protector 100 in a full spooling operation before being led toward the front 16 of the cassette 10.

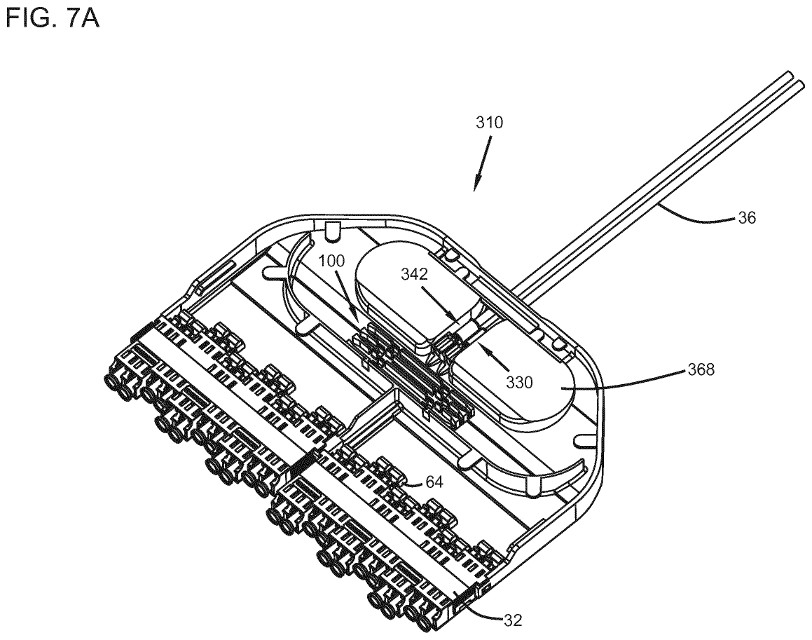

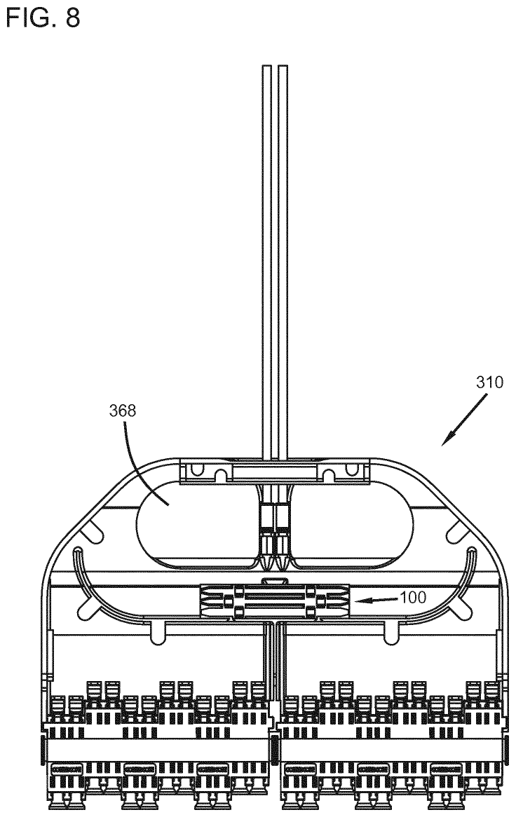

If the routing illustrated in FIG. 6 is preferred for a given application, a cassette such as the cassette 310 shown in FIGS. 7-9 may be used. The embodiment of the cassette 310 shown in FIGS. 7-9 includes a generally single piece radius limiter 368 that is divided into two halves by a pocket 342 at a cable entry 330.

The single piece radius limiter 368 facilitates full spooling of the fibers 56 if a routing configuration similar to the one illustrated in FIG. 6 is used.

As noted above, the splice protector inserts 100 may be configured depending on the needed application. They can have different numbers of channels 108 for different numbers of possible repair splices 102.

Although all of the embodiments discussed with respect to FIGS. 1-9 illustrate factory terminated connectors 64, in certain embodiments of the cassettes, the fibers 56 extending from the input cables 36 may be provided as a ribbon fiber wherein the individual fibers 56 of the ribbon are factory spliced to the internal connectors 64, instead of direct factory termination of these optical fibers 56 to the connectors 64. Thus, it should be noted that the term “factory-terminated” may include “direct termination” of a fiber optic connector 64 to an end of an optical fiber 56 at the factory level that does not involve a splice operation. However, the term “factory-terminated” may also include “factory-splicing” of a fiber optic connector pigtail 56 to a length of optical fiber 56 at the factory level.

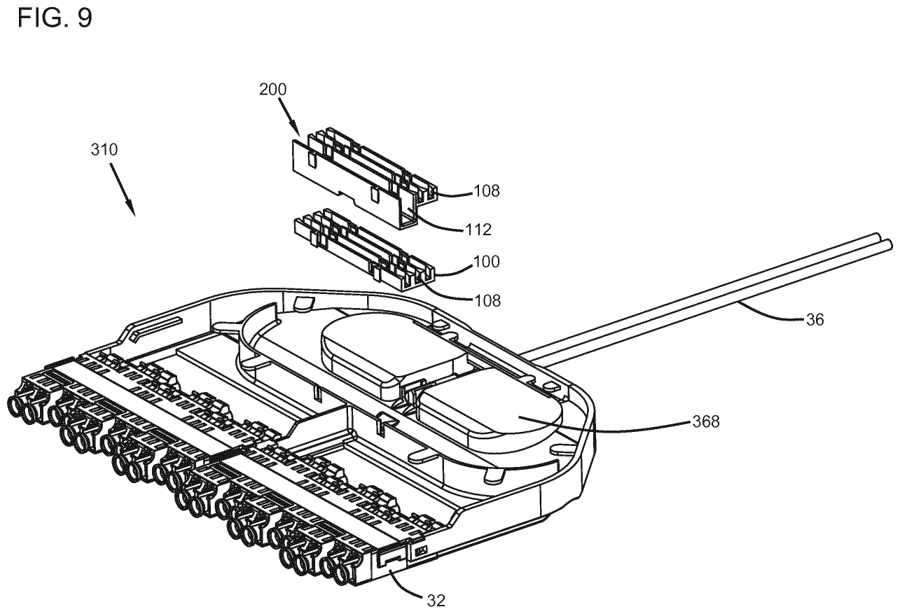

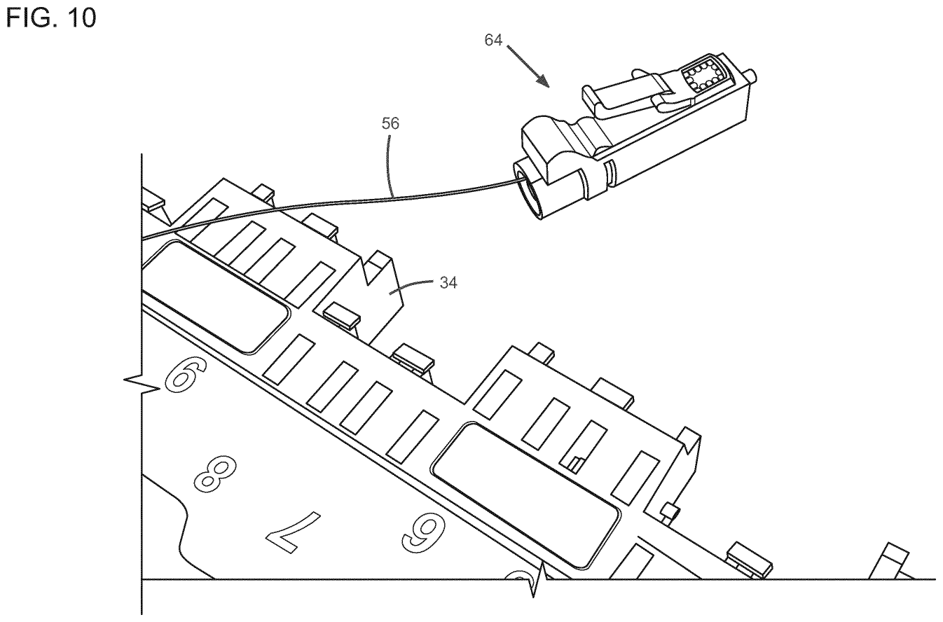

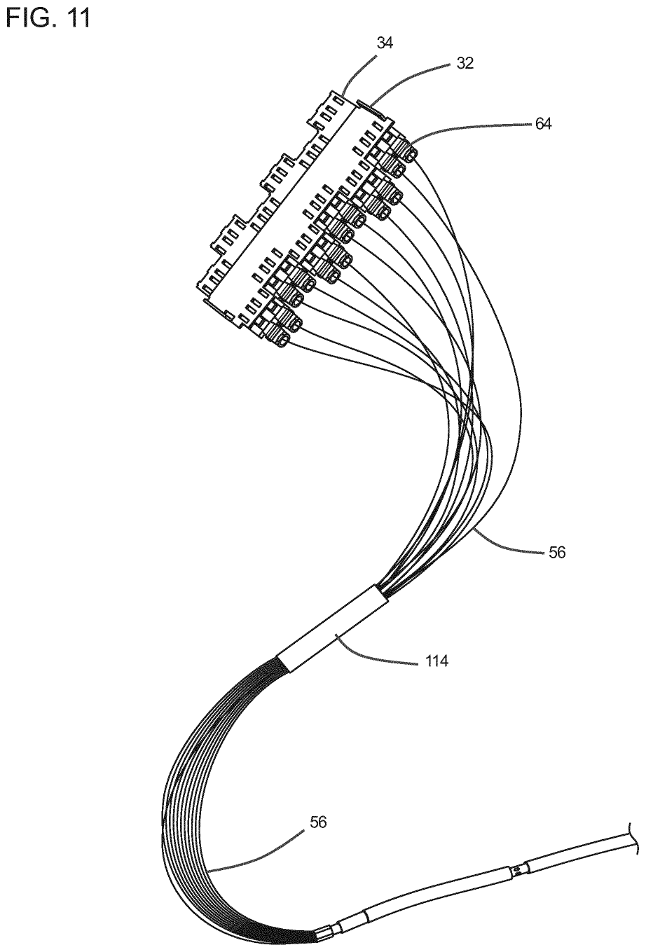

FIG. 11 illustrates “factory-terminated” fiber optic connectors 64 that have been factory-spliced to optical fibers 56 at the factory level. In FIG. 11, a twelve-fiber ribbon 56 has been factory spliced to internal connectors 64 leading to the adapters 34 of one of the cassettes 10, 310 of FIGS. 1-9 instead of direct factory termination of the optical fibers 56 coming into the cassettes 10, 310. Thus, certain splice protector inserts of the cassettes may be configured to hold such factory splices 114 and may be referred to as factory splice protectors 200 instead of repair splice protectors 100. For example, the cassette 310 illustrated in FIG. 9 is shown with two different examples of splice protector inserts that may be used therein, wherein one of the splice protector inserts defines a specific channel 112 for supporting a factory splice 114 that is used to splice a ribbon 56 to fiber optic connectors 64. As noted previously, such a factory splice 114 (shown in FIG. 11) may be housed within the front-most, larger channel 112 defined by the splice protector 100 (shown in FIGS. 3-6 and 9) and the other two channels 108 may be used for repair splices 102 as discussed above.

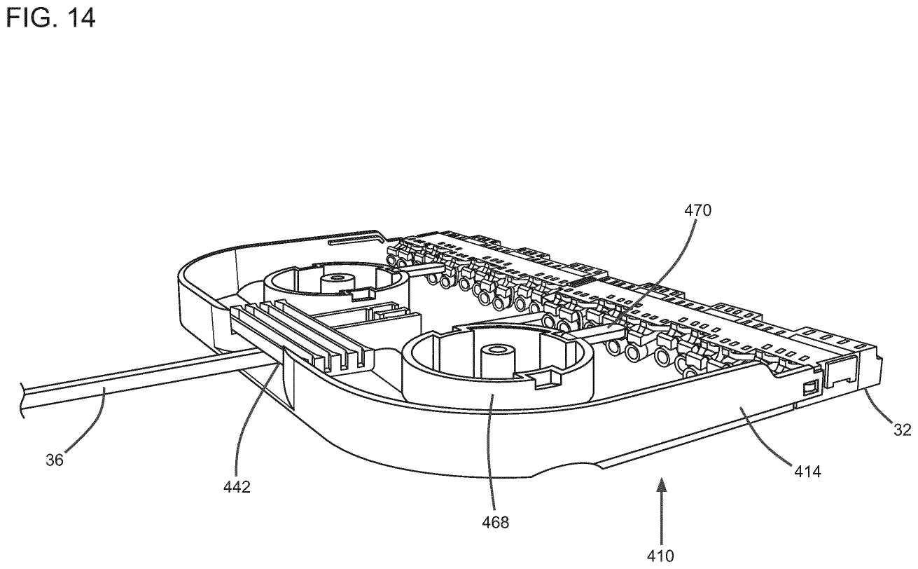

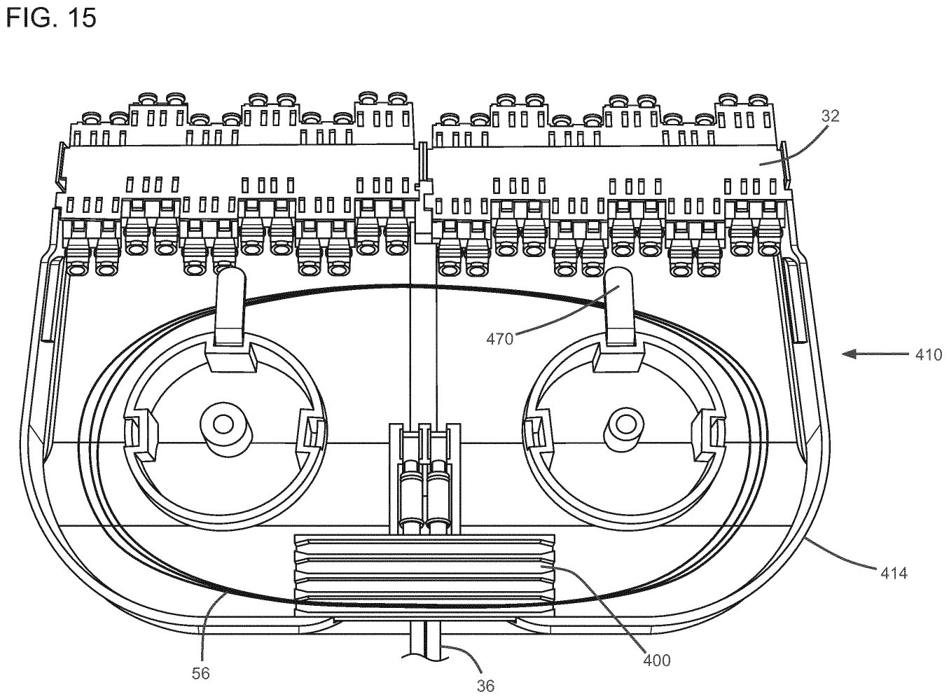

Referring now to FIGS. 13-15, a fiber optic cassette 410 having features that are similar to those of the cassettes 10, 310 of FIGS. 1-9 is shown. The cassette 410, as shown, defines an alternative location for a splice protector insert 400. In the cassette 410, the splice protector insert 400 also serves the functionality of the bridge discussed above and is positioned above a pocket 442 defined at a cable entry 430. Such a positioning of the splice protector 400 allows channels 408 thereof to be repair splice supports or to define pathways for routing the fibers 56 between the right and left sides of a cassette body 414. For example, FIG. 15 illustrates the fiber optic cassette 410 of FIGS. 13-14 with an example fiber routing configuration that uses one of the channels 408 of the splice protector insert 400 for routing a fiber 56 to utilize the full cassette width.

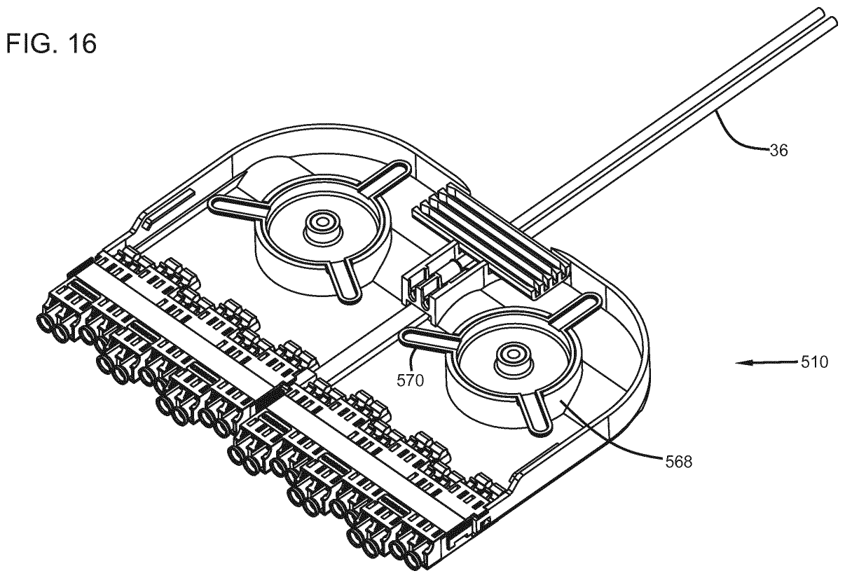

Referring now to FIGS. 16-18, a fiber optic cassette 510 having features that are similar to those of the cassette 410 of FIGS. 13-15 is illustrated. The cassette 510 of FIGS. 16-18 utilizes alternative versions of cable management features 568 therewithin. Whereas the cassette 410 of FIGS. 13-15 is illustrated with radius limiters 468 that have removable cable retention fingers 470, the cassette 510 of FIGS. 16-18 has fully circular cable retention caps 569 with fingers 570 extending outwardly therefrom that are inserted into the spools 568 of the cassette 510.

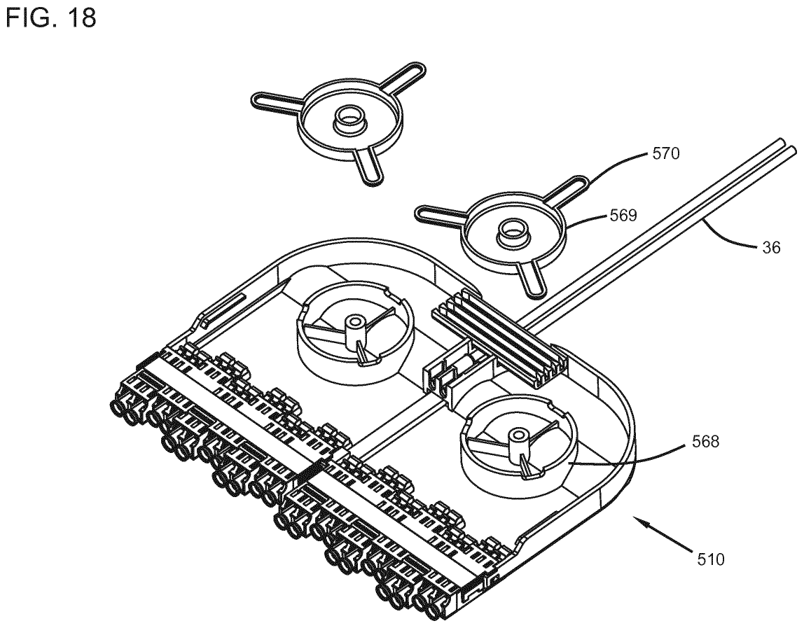

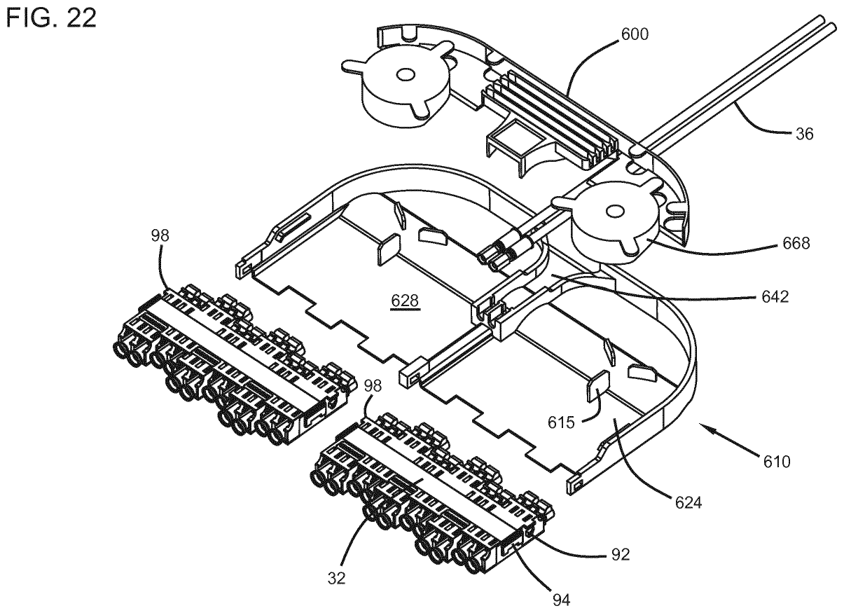

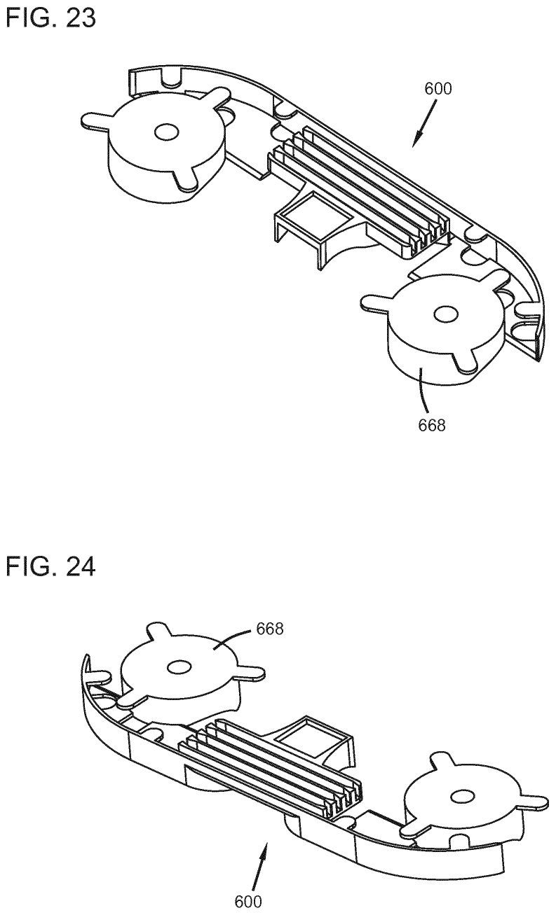

Now referring to FIGS. 19-22, another embodiment of a fiber optic cassette 610 having features that are similar to those of the cassettes 410, 510 of FIGS. 13-18 is illustrated. The cassette 610 of FIGS. 19-22 includes an alternative version of a splice protector insert 600 that includes integrally formed cable management spools 668. The cassette 610 of FIGS. 19-22 includes an insert 600 that combines a rear-located splice protector that is above a pocket 642 with spools 668 that are integrally molded as part of the insert 600. The insert 600 is simply placed into the cassette interior 628 to capture the input cables 36 within the pocket 642. As shown, a bottom wall 624 of a cassette body 614 may include keying or guiding tabs 615 that are used to position the spools 668 of the insert 600 in the correct positioning. The insert 600 is shown in isolation in FIGS. 23-24.

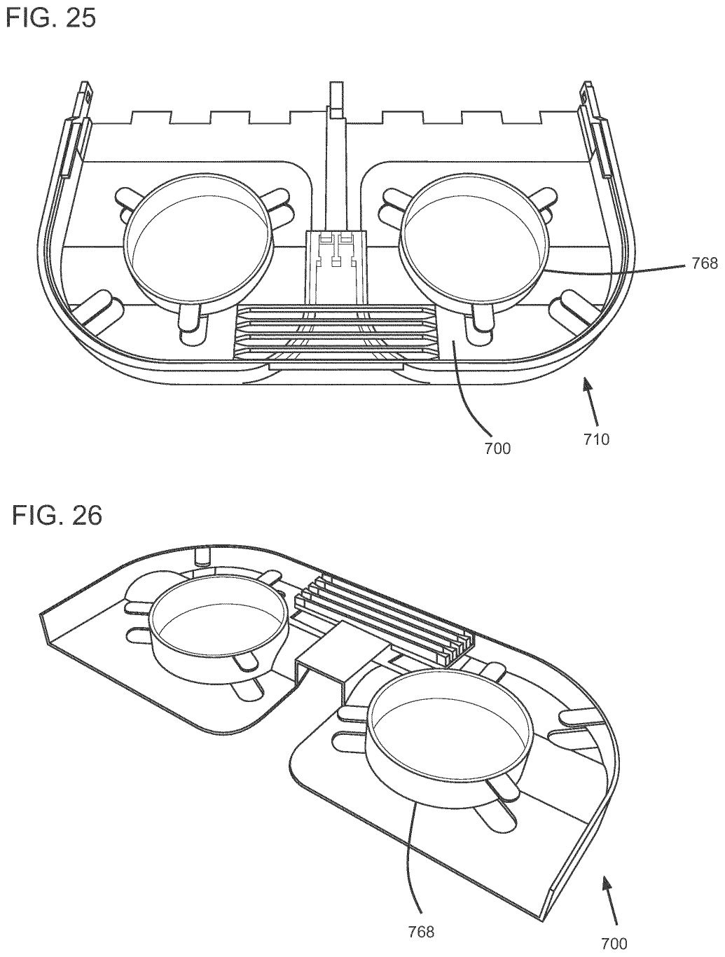

FIG. 25 illustrates another embodiment of a fiber optic cassette 710 having features that are similar to those of the cassette 610 of FIGS. 19-22. The cassette 710 of FIG. 25 includes an alternative version of a splice protector insert 700 that includes integrally formed cable management spools 768. The insert 700 is shown in isolation in FIG. 26.

As discussed above, in certain embodiments of cassettes, the fibers 56 extending from the input cables 36 may be provided as a ribbon fiber 56 wherein the individual fibers 56 of the ribbon are factory spliced to the internal connectors 64 (as illustrated in FIG. 11), instead of direct factory termination of these optical fibers 56 to the connectors 64.

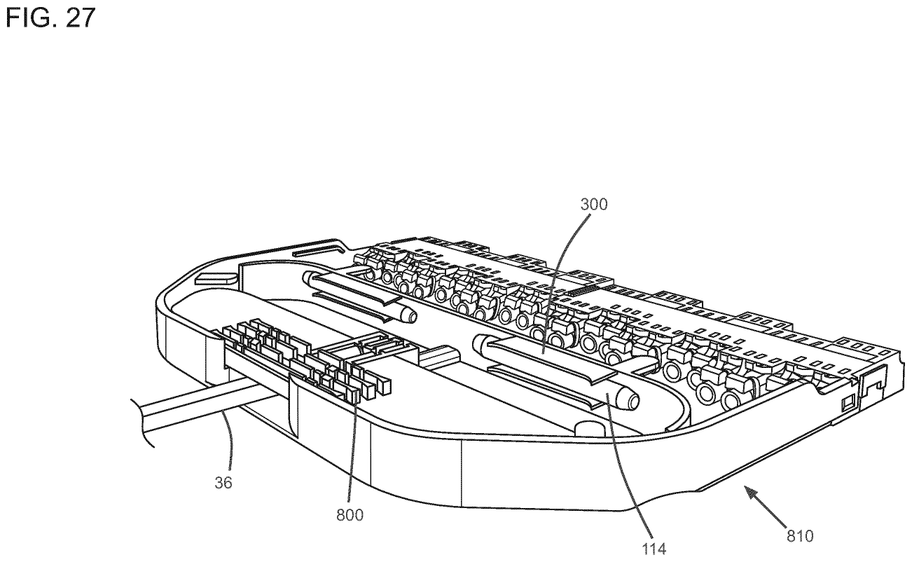

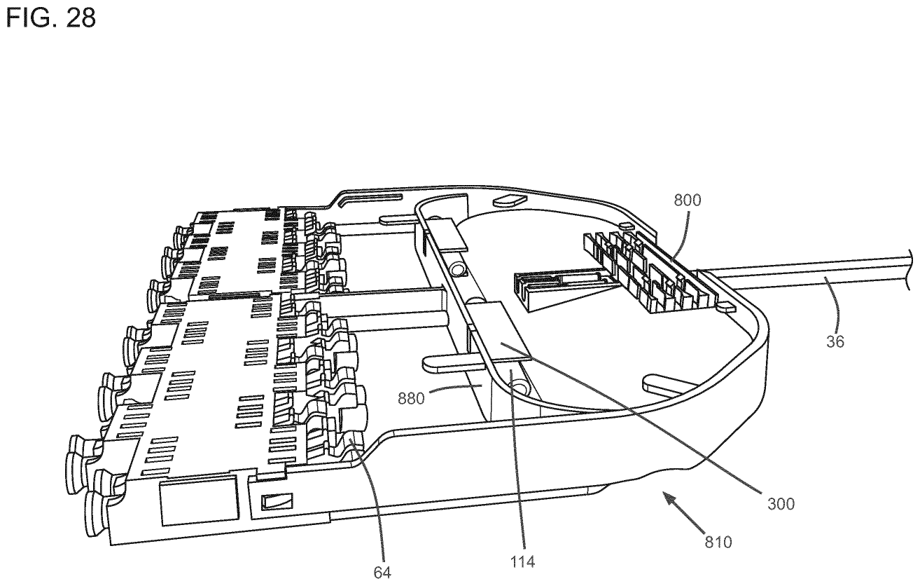

FIGS. 27-29 illustrate an embodiment of a fiber optic cassette 810 that includes a splice protector insert 800 for repair splices as well as splice protectors 300 for holding splices 114 that are used for factory splicing of the internal connectors 64 to fiber ribbons 56. In the depicted example, the factory splice protectors 300 (one for each of the ribbons 56 going to the right adapter block 32 and the left adapter block 32) are mounted to a wall structure 880. The factory splice protectors 300 are provided as removable pieces that are slidably mounted to the wall 880 with dovetail structures 304.

In the example shown, the repair splice protector 800 is located at the rear of a cassette body 814 above a pocket 842.

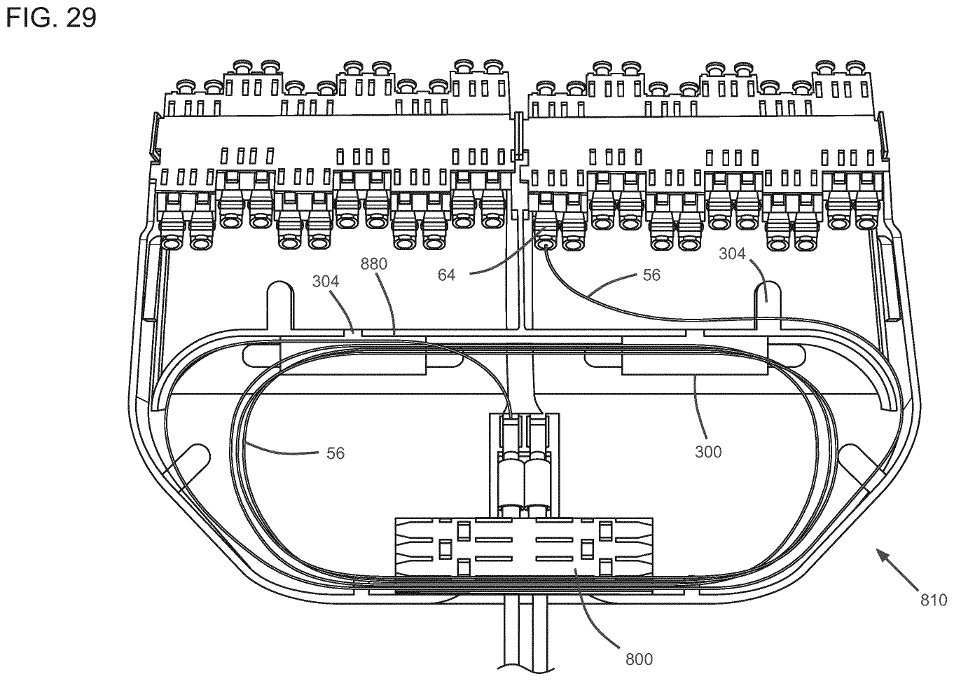

FIG. 29 illustrates an example fiber routing configuration for a factory spliced internal connector 64 where the ribbon 56 is looped around the entire interior perimeter of the cassette body 814 before being led to the adapter blocks 32.

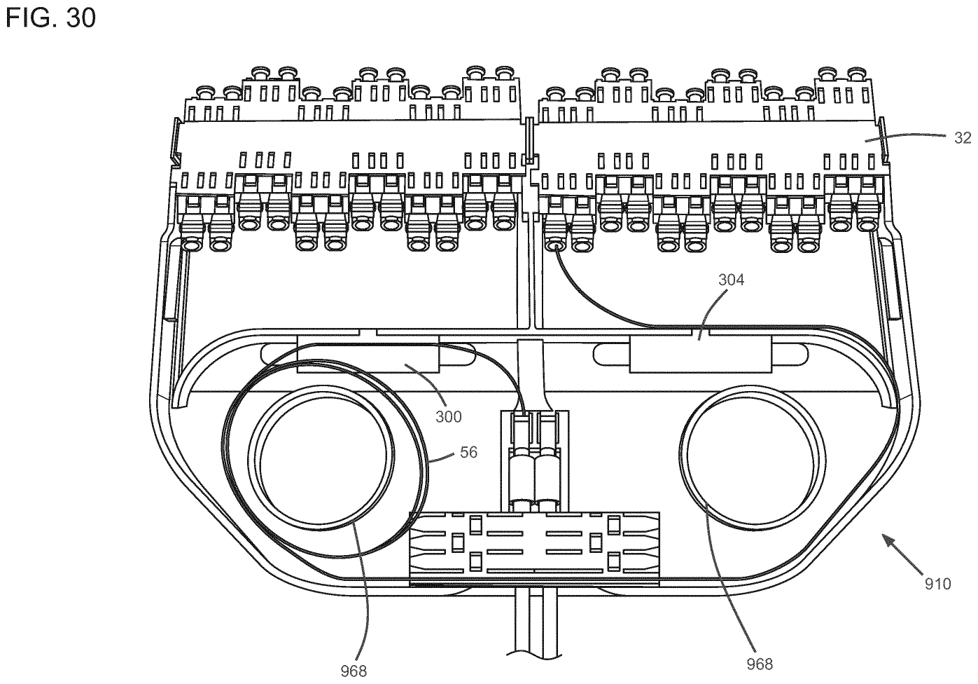

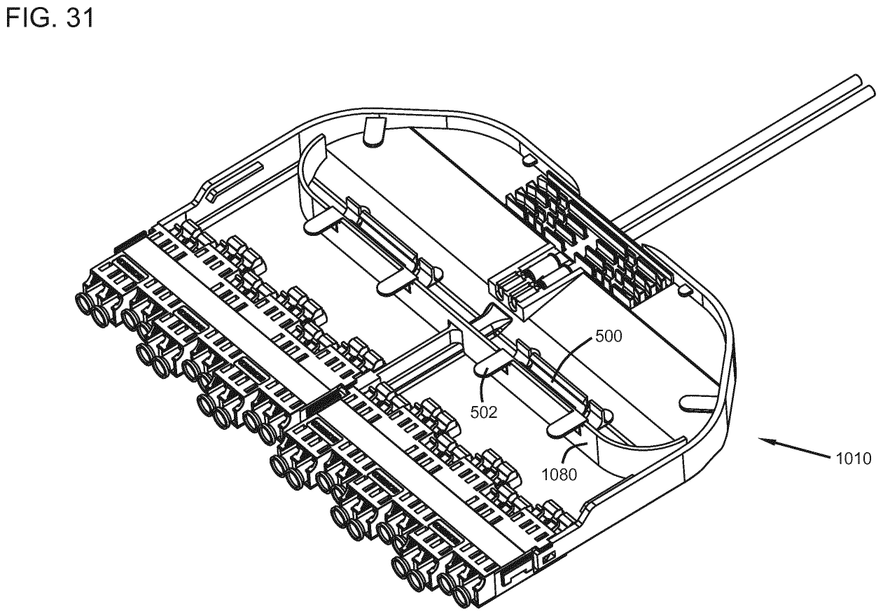

FIG. 30 illustrates a fiber optic cassette 910 similar to the cassette 810 of FIGS. 27-29 that includes additional molded cable management spools 968 that are used to illustrate an alternative fiber routing configuration for a factory spliced internal connector 64. In the cassette 910 of FIG. 30, the factory spliced ribbon 56 for the left adapter block 32 is led around the right spool 968 before heading to the adapter block 32. The same routing configuration is used for the factory spliced ribbon 56 that goes to the right adapter block 32 but in a reversed direction relative to that of the shown ribbon 56.

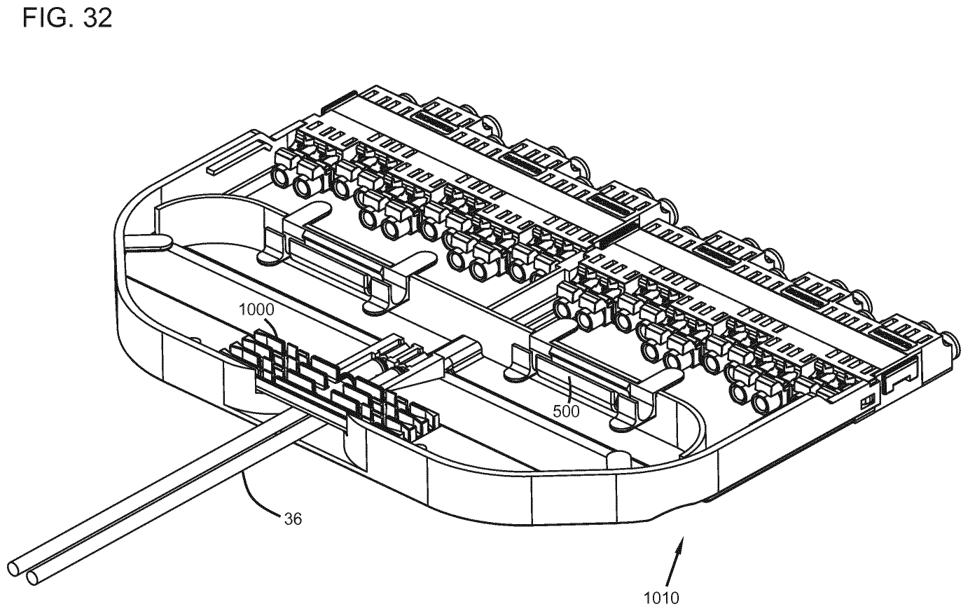

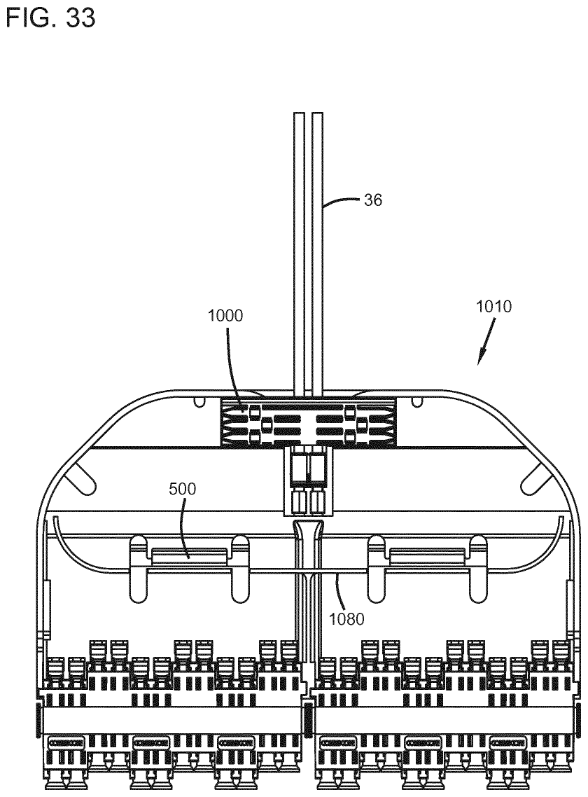

FIGS. 31-33 illustrate a fiber optic cassette 1010 having similar features to the cassettes 810, 910 shown in FIGS. 27-30, the cassette 1010 having an alternative version of the splice protectors 500 for holding factory splices 114 of the internal connectors 64. As shown, the factory splice protectors 500 have keys 504 that are slidably placed within notches 1106 on a wall 1080 of a cassette body 1014. The factory splice protectors 500 also include cable retention fingers 502 that are integrally formed therewith that extend forwardly from the wall 1080 when the protectors 500 have been mounted to the cassette 1010.

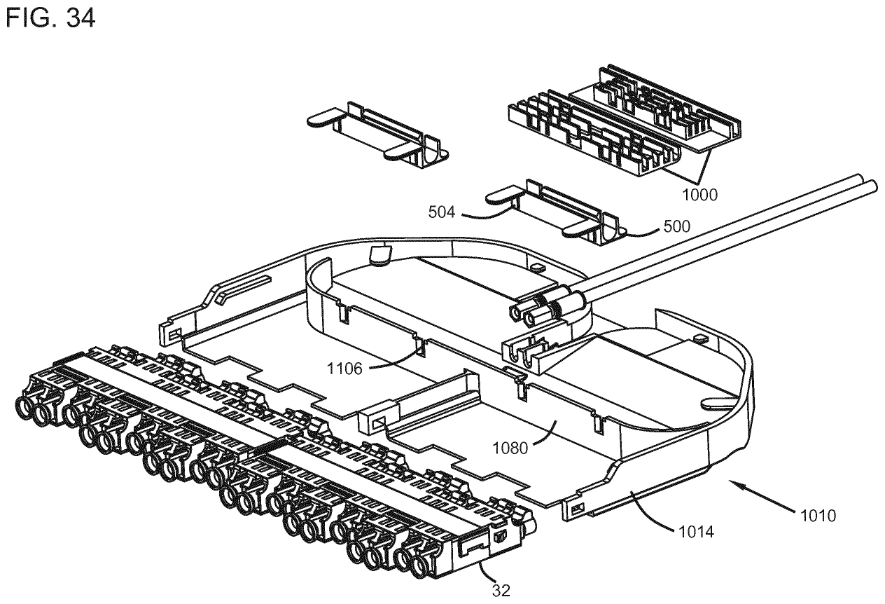

FIG. 34 illustrates the cassette 1010 of FIGS. 31-33 with two different examples of splice protector inserts 1000 for repair splices that may be used therein, the repair splice protector inserts shown exploded off the cassette body 1014.

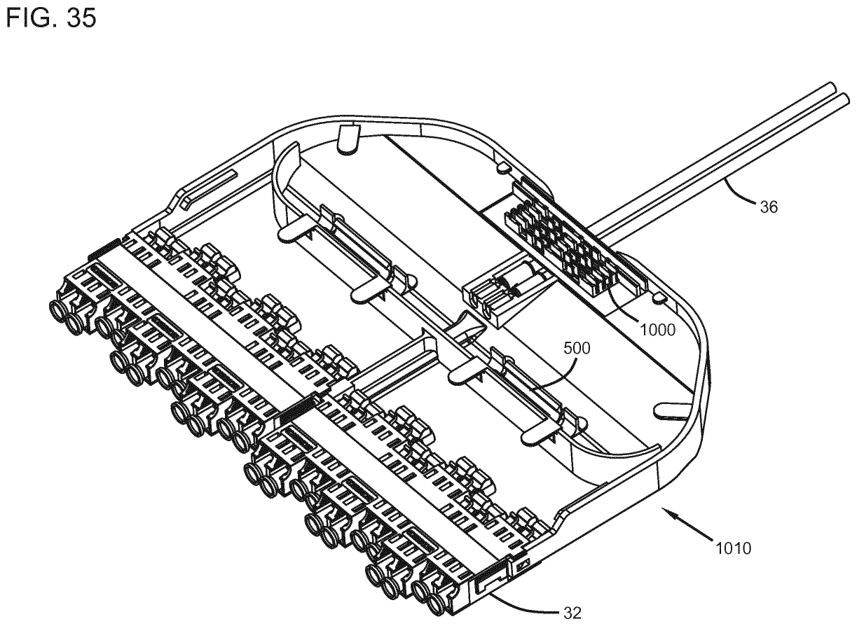

FIG. 35 illustrates the cassette 1010 of FIG. 34 with one of the repair splice protector inserts 1000 mounted to the cassette body 1014, the splice protector insert 1000 having a different configuration than the insert shown in the cassette 1010 of FIGS. 31-33.

Although in the foregoing description, terms such as “top,” “bottom,” “front,” “back,” “right,” “left,” “upper,” and “lower,” were used for ease of description and illustration, no restriction is intended by such use of the terms. The telecommunications devices described herein can be used in any orientation, depending upon the desired application.

Having described the preferred aspects and embodiments of the present invention, modifications and equivalents of the disclosed concepts may readily occur to one skilled in the art. However, it is intended that such modifications and equivalents be included within the scope of the claims which are appended hereto.

### LIST OF REFERENCE NUMERALS AND CORRESPONDING FEATURES

10—fiber optic cassette
12—tray
14—cassette body
16—front
18—rear wall
20—right sidewall
22—left sidewall
24—bottom wall
26—cover
28—interior
30—cable entry or crimp location
32—adapter block
34—fiber optic adapter
36—cable
38—crimp tube
40—crimp ring
42—pocket
44—hex end of crimp tube
46—inset portion
48—right curved portion of rear wall
50—left curved portion of rear wall
52—bridge
54—channel/pathway
56—optical fiber or ribbon
58—cable retention finger of bridge
60—rear of adapter
62—front of adapter
64—interior fiber optic connector
66—chamber
68—radius limiter or spool
70—cable retention finger of spool
72—bulkhead
74—curved surface of bulkhead
76—fiber pathway
78—cable retention finger of bulkhead
80—wall
82—curved portion of wall
84—cable retention finger of wall
86—central divider portion of wall
88—raised edge
90—adapter block body
92—ramped tab of adapter block
94—dovetail mounting structure of adapter block
96—opening
98—protrusion of adapter block
100—repair splice protector or splice support tray
102—repair splice
104—dovetail shaped tab of splice protector
106—notch of wall
108—channel
110—splice retention arm
112—large channel for holding factory splice
114—factory splice
200—factory splice protector
210—fiber optic cassette
214—cassette body
232—hinged adapter block
300—factory splice protector
304—dovetail structure
310—fiber optic cassette
330—cable entry
342—pocket
368—radius limiter
400—repair splice protector
408—channel
410—fiber optic cassette
414—cassette body
430—cable entry
442—pocket
468—radius limiter
470—cable retention finger
500—factory splice protector
502—cable retention finger
504—key
510—fiber optic cassette
568—cable management feature or spool
569—cable retention cap
570—cable retention finger
600—splice protector insert
610—fiber optic cassette
614—cassette body
615'keying tab
624—bottom wall
628—interior
642—pocket
668—cable management spool
700—splice protector insert
710—fiber optic cassette
768—cable management spool
800—splice protector insert
810—fiber optic cassette
814—cassette body
842—pocket
880—wall
910—fiber optic cassette
968—cable management spool
1000—repair splice protector insert
1010—fiber optic cassette
1014—cassette body
1080—wall
1106—notch

1. A fiber optic cassette comprising:
a body defining an interior;
a fiber optic signal entry location defined on the body for a fiber optic signal to enter the interior of the cassette via a fiber optic cable;
a plurality of connection locations defined on the body, wherein optical fibers that are factory-terminated with fiber optic connectors extend from the cable at the signal entry location to the connection locations of the body for connection to external fiber optic connectors, wherein all of the optical fibers within the interior extend from the cable at the signal entry location to the plurality of connection locations; and
an empty repair splice protector positioned within the interior, the empty repair splice protector provided in addition to the cable that has every one of its fibers leading to the plurality of connection locations of the body, the empty repair splice protector configured for supporting at least one repair splice for one of the optical fibers within the cassette if a factory-terminated connector gets damaged.

2. A fiber optic cassette according to claim 1, wherein at least some of the factory-terminated fiber optic connectors within the cassette are directly terminated to the fibers without a splice.

3. A fiber optic cassette according to claim 1, wherein at least some of the factory-terminated fiber optic connectors within the cassette are factory-spliced to the fibers.

4. A fiber optic cassette according to claim 3, wherein the cassette includes a factory splice protector for supporting the factory splice of the connectors in addition to the empty repair splice protector within the cassette.

5. A fiber optic cassette according to claim 1, wherein the empty repair splice protector is an insert that is removably mounted to the cassette body.

6. A fiber optic cassette according to claim 4, wherein the factory splice protector is an insert that is removably mounted to the cassette body.

7. A fiber optic cassette according to claim 4, wherein the empty repair splice protector and the factory splice protector are integrally formed by the same structure.

8. A fiber optic cassette according to claim 4, wherein the factory splice protector is configured to hold a factory splice for connecting a twelve-fiber ribbon to the fiber optic connectors.

9. A fiber optic cassette according to claim 1, wherein the factory-terminated fiber optic connectors are of LC format.

10. A fiber optic cassette according to claim 1, wherein the cassette includes at least one cable management structure within the interior for guiding both the factory-terminated fibers and any splice-repaired fibers from the signal entry location to the connection locations of the cassette.

11. A fiber optic cassette according to claim 10, wherein the at least one cable management structure is provided as a removable structure.

12. A fiber optic cassette according to claim 11, wherein the removable cable management structure is an integral portion of the empty repair splice protector that is also removably mounted to the cassette body as an insert.

13. A fiber optic cassette according to claim 1, wherein the connection locations are defined by fiber optic adapters each including an inner end for receiving one of the factory-terminated fiber optic connectors and an outer end for receiving an external fiber optic connector for coupling with the factory-terminated fiber optic connector.

14. A fiber optic cassette according to claim 13, wherein the fiber optic adapters are integrally molded as a unitary piece to define an adapter block that is removably mounted to the cassette.

15. A fiber optic cassette according to claim 14, wherein the adapter block defines a first coupling structure for mounting the adapter block to the cassette and defines a second coupling structure for mounting the adapter block, along with the cassette, to a telecommunications fixture, wherein the second coupling structure allows the adapter block to also be configured as a stand-alone structure that can be mounted to the telecommunications fixture by itself without being mounted to the cassette body.

16. A method of assembling a fiber optic cassette, the method comprising:
providing a fiber optic signal entry location on the cassette;
extending a plurality of optical fibers into an interior of the cassette from the signal entry location;
factory-terminating the optical fibers with fiber optic connectors;
coupling the factory-terminated fiber optic connectors to connection locations within the interior of the cassette for connection to external fiber optic connectors to come from an exterior of the cassette, wherein all of the optical fibers within the interior extend from the signal entry location to the connection locations; and
providing an empty repair splice protector within the interior configured for supporting at least one repair splice for one of the optical fibers within the cassette if a factory-terminated connector gets damaged, the empty repair splice protector provided in addition to all of the optical fibers leading to the connection locations within the cassette of the body.

17. A method according to claim 16, wherein at least some of the factory-terminated fiber optic connectors within the cassette are directly terminated to the fibers without a splice.

18. A method according to claim 16, wherein at least some of the factory-terminated fiber optic connectors within the cassette are factory-spliced to the optical fibers.

19. A method according to claim 18, further comprising providing a factory splice protector for supporting the factory splice of the connectors in addition to the empty repair splice protector within the cassette.

20. A method according to claim 19, wherein the empty repair splice protector and the factory splice protector are integrally formed by the same structure.

21. A method according to claim 16, further comprising repairing one of the optical fibers that has been factory-terminated to a fiber optic connector with a splice operation and positioning the splice within the empty repair splice protector.

22. A fiber optic cassette comprising:
a body defining a front and an opposite rear and an enclosed interior;
a removable cover coupled to the body to enclose the interior;
a fiber optic signal entry location defined at the rear of the body for a fiber optic signal to enter the interior of the cassette via a fiber optic cable;
an adapter block defining a plurality of fiber optic adapters located at the front of the body, the adapter block removably mounted to the cassette body with a snap-fit interlock, each adapter of the block including a front outer end, a rear inner end, and internal structures which allow mating of fiber optic connectors that are mounted to the front and rear ends, respectively, wherein optical fibers that are factory-terminated with fiber optic connectors extend from the cable at the signal entry location to the rear ends of at least some of the fiber optic adapters of the snap-fit adapter block for relaying the fiber optic signal to external fiber optic connectors to be coupled to the front outer ends of the adapters, wherein all of the optical fibers within the interior extend from the cable at the signal entry location to at least some of the fiber optic adapters of the adapter block; and
an empty repair splice protector positioned within the interior, the empty repair splice protector provided in addition to the cable that has every one of its fibers leading to plurality of fiber optic adapters of the body, the empty repair splice protector configured for supporting at least one repair splice for one of the optical fibers within the cassette if a factory-terminated connector gets damaged.

23. A fiber optic cassette according to claim 22, wherein at least some of the factory-terminated fiber optic connectors within the cassette are directly terminated to the fibers without a splice.

24. A fiber optic cassette according to claim 22, wherein at least some of the factory-terminated fiber optic connectors within the cassette are factory-spliced to the fibers.

25. A fiber optic cassette according to claim 24, wherein the cassette includes a factory splice protector for supporting the factory splice of the connectors in addition to the empty repair splice protector within the cassette.

26. A fiber optic cassette according to claim 22, wherein the empty repair splice protector is an insert that is removably mounted to the cassette body.

27. A fiber optic cassette according to claim 22, wherein the adapter block can pivot with respect to the cassette body for facilitating access to the factory-terminated fiber optic connectors coupled to the rear ends of the fiber optic adapters.
